(19) United States
(12) Patent Application Publication
(10) Pub. No.: US 2025/0071583 A1
(43) Pub. Date: Feb. 27, 2025

(54) SIGNAL MONITORING METHOD, CONFIGURATION METHOD, APPARATUS, UE, AND NETWORK SIDE DEVICE

(71) Applicant: VIVO MOBILE COMMUNICATION CO., LTD., Dongguan (CN)

(72) Inventor: Yangyang WANG, Dongguan (CN)

(73) Assignee: VIVO MOBILE COMMUNICATION CO., LTD., Dongguan (CN)

(21) Appl. No.: 18/942,307

(22) Filed: Nov. 8, 2024

Related U.S. Application Data
(63) Continuation of application No. PCT/CN2023/092244, filed on May 5, 2023.

(30) Foreign Application Priority Data
May 9, 2022 (CN) 202210501748.4

(51) Int. Cl. H04W 24/08; H04W 52/02; H04W 72/02; H04W 72/0453; H04W 76/20; H04W 76/30

(52) U.S. Cl. CPC H04W 24/08; H04W 52/0235; H04W 72/02; H04W 72/0453; H04W 76/20; H04W 76/30

(57) ABSTRACT

A signal monitoring method, a configuration method, and a User Equipment (UE) are provided. The signal monitoring method includes: determining, by a UE, a first frequency that needs to be monitored; and monitoring a first signal corresponding to the first frequency in a low-power state. The first signal is a signal that the UE needs to monitor in the low-power state, and the first signal is not a wake-up signal.

### CROSS-REFERENCE TO RELATED APPLICATIONS

This application is a continuation of International Application No. PCT/CN2023/092244, filed on May 5, 2023, which claims the priority of Chinese Patent Application No. 202210501748.4 filed on May 9, 2022. The entire contents of each of the above-referenced applications are expressly incorporated herein by reference.

### TECHNICAL FIELD

This application relates to the field of communication technologies, and specifically, to a signal monitoring method, a configuration method, an apparatus, a UE, and a network side device.

### BACKGROUND

When a low-power wake-up signal is introduced in a mobile cellular system, a network side device does not send the wake-up signal to a UE most of time, and the UE needs to continuously monitor the wake-up signal to wake up a main communication module at any time. However, if a target wake-up signal is not monitored within a time period, it is possible that the UE cannot determine whether the UE is still in a service range, whether the UE maintains synchronization with a network, and the like. In this case, a signal that the UE needs to monitor in a low-power state, such as a low-power beacon signal, may be introduced, so that the UE maintains synchronization with the network and the like by monitoring or detecting the signal. However, it is currently not determined how to monitor such signals.

### SUMMARY

Embodiments of this application provide a signal monitoring method, a configuration method, an apparatus, a UE, and a network side device, so that a UE can monitor a signal that the UE needs to monitor in a low-power state.

According to a first aspect, a signal monitoring method is provided, including:
determining, by a UE, a first frequency that needs to be monitored; and
monitoring, by the UE, a first signal corresponding to the first frequency in a low-power state, where the first signal is not a wake-up signal.

According to a second aspect, a configuration method is provided, including:
sending, by a network side device, a first message to a UE, where the first message includes: at least one set of configuration information of a first signal; and each set of configuration information of the first signal includes a frequency identifier, the first signal is a signal that needs to be monitored by the UE in a low-power state, and the first signal is not a wake-up signal.

According to a third aspect, a signal monitoring apparatus is provided, used in a UE, and including:
a determining module, configured to determine a first frequency that needs to be monitored; and
a monitoring module, configured to monitor a first signal corresponding to the first frequency in a low-power state, where the first signal is not a wake-up signal.

According to a fourth aspect, a configuration apparatus is provided, used in a network side device, and including:
a sending module, configured to send a first message to a UE, where the first message includes: at least one set of configuration information of a first signal; and each set of configuration information of the first signal includes a frequency identifier, the first signal is a signal that needs to be monitored by the UE in a low-power state, and the first signal is not a wake-up signal.

According to a fifth aspect, a UE is provided. The UE includes a processor and a memory. The memory has a program or instructions executable on the processor stored therein. When the program or the instructions are executed by the processor, the steps of the method according to the first aspect are implemented.

According to a sixth aspect, a UE is provided, including a processor and a communication interface. The processor is configured to determine a first frequency that needs to be monitored; and monitor a first signal corresponding to the first frequency in a low-power state. The first signal is not a wake-up signal.

According to a seventh aspect, a network side device is provided. The network side device includes a processor and a memory. The memory has a program or instructions executable on the processor stored therein. When the program or the instructions are executed by the processor, the steps of the method according to the second aspect are implemented.

According to an eighth aspect, a network side device is provided, including a processor and a communication interface. The communication interface is configured to send a first message to a UE. The first message includes: at least one set of configuration information of a first signal; and each set of configuration information of the first signal includes a frequency identifier, the first signal is a signal that needs to be monitored by the UE in a low-power state, and the first signal is not a wake-up signal.

According to a ninth aspect, a communication system is provided, including: a UE and a network side device. The UE may be configured to perform the steps of the signal monitoring method according to the first aspect, and the network side device may be configured to perform the steps of the configuration method according to the second aspect.

According to a tenth aspect, a readable storage medium is provided. The readable storage medium has a program or instructions stored therein. When the program or the instructions are executed by the processor, the steps of the method according to the first aspect are implemented, or the steps of the method according to the second aspect are implemented.

According to an eleventh aspect, a chip is provided. The chip includes a processor and a communication interface. The communication interface is coupled to the processor. The processor is configured to execute a program or instructions, to implement the steps of the method according to the first aspect, or implement the steps of the method according to the second aspect.

According to a twelfth aspect, a computer program/program product is provided. The computer program/program product is stored in a storage medium. The computer program/program product is executed by at least one processor, to implement the steps of the method according to the first aspect, or implement the steps of the method according to the second aspect.

In the embodiments of this application, a UE may determine a first frequency that needs to be monitored, and monitor a first signal corresponding to the first frequency in a low-power state. The first signal is a signal that the UE needs to monitor in the low-power state. Therefore, a first signal may be associated with a frequency, so that the UE can monitor the first signal corresponding to the frequency in the low-power state.

### BRIEF DESCRIPTION OF THE DRAWINGS

FIG. 1 is a block diagram of a wireless communication system to which embodiments of this application are applicable;

FIG. 2 is a schematic diagram of a working state of a UE according to an embodiment of this application;

FIG. 3 is a flowchart of a signal monitoring method according to an embodiment of this application;

FIG. 4 is a flowchart of a configuration method according to an embodiment of this application;

FIG. 5A is a first schematic diagram of distribution of a monitored signal in time domain according to an embodiment of this application;

FIG. 5B is a second schematic diagram of distribution of a monitored signal in time domain according to an embodiment of this application;

FIG. 6 is a schematic structural diagram of a signal monitoring apparatus according to an embodiment of this application;

FIG. 7 is a schematic structural diagram of a configuration apparatus according to an embodiment of this application;

FIG. 8 is a schematic structural diagram of a communication device according to an embodiment of this application;

FIG. 9 is a schematic structural diagram of a UE according to an embodiment of this application; and

FIG. 10 is a schematic structural diagram of a network side device according to an embodiment of this application.

### DETAILED DESCRIPTION

The following clearly describes the technical solutions in embodiments of this application with reference to the accompanying drawings in the embodiments of this application. Apparently, the described embodiments are some of the embodiments of this application rather than all of the embodiments. All other embodiments obtained by a person of ordinary skill in the art based on the embodiments of this application shall fall within the protection scope of this application.

The terms “first”, “second”, and the like in the specification and claims of this application are used to distinguish between similar objects, but are not used to describe a specific sequence or order. It should be understood that the terms used in such a way are interchangeable in proper circumstances, so that the embodiments of this application described herein can be implemented in other sequences than the sequence illustrated or described herein. In addition, the objects distinguished by using “first” and “second” are usually of a type, and the number of the objects is not limited. For example, the number of the first objects may be one or more. In addition, “and/or” in the specification and claims represents at least one of the connected objects. The character “/” generally represents an “or” relationship between the associated objects.

It should be noted that the technologies described in the embodiments of this application are not limited to a Long Term Evolution (LTE)/LTE-Advanced (LTE-A) system, and may be applied to other wireless communication systems, such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), or another system. The terms “system” and “network” in the embodiments of this application may usually be used interchangeably. The technology described can be applied to the systems and radio technologies mentioned above, and can also be applied to other systems and radio technologies. The following descriptions describe a New Radio (NR) system for example purposes, and NR terms are used in most of the following descriptions. However, the technologies are also applicable to applications other than NR system applications, such as a 6^{th} Generation (6G) communication system.

FIG. 1 is a block diagram of a wireless communication system to which embodiments of this application are applicable. The wireless communication system includes a UE 11 and a network side device 12. The UE 11 may be a UE side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, a Vehicle User Equipment (VUE), a Pedestrian User Equipment (PUE), a smart home (a home device having a wireless communication function, for example, a refrigerator, a television, a washing machine, or furniture), a game console, a Personal Computer (PC), a teller machine, or an automated machine. The wearable device includes: a smart watch, a smart bracelet, a smart earphone, smart glasses, smart jewelry (a smart bangle, a smart wrist chain, a smart ring, a smart necklace, a smart anklet, a smart ankle chain, and the like), a smart wristband, smart clothes, and the like. It should be noted that a specific type of the UE 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home eNB, a Transmission and Reception Point (TRP), or another proper term in the field. Provided that the same technical effect is achieved, the base station is not limited to a specific technical term. It should be noted that a base station in an NR system is only used as an example for description in the embodiments of this application, and a specific type of the base station is not limited.

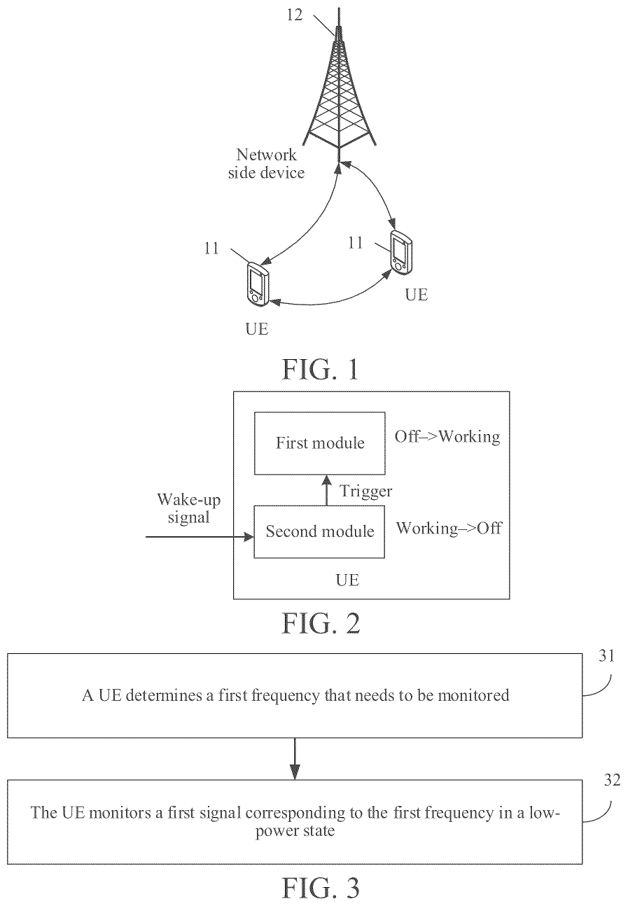

In the embodiments of this application, as shown in FIG. 2, the UE may include two modules. A first module is a main communication module, configured to send and receive mobile communication data. A second module is a low-power wake-up receiving module, configured to receive a low-power wake-up signal and a low-power beacon signal that are sent by a sending end. The low-power wake-up signal is used for waking up the main communication module. The low-power beacon signal is used for providing time reference information and other information for receiving the low-power wake-up signal, and may be further used for providing wake-up link management. When not woken up by the second module, the first module is always in an off state and does not send/receive data. When downlink data reaches, the second module detects a wake-up signal sent by the sending end, and the wake-up signal includes information about the UE, the second module triggers the first module to switch from the off state to a working state, to receive and/or send data. When the second module is turned on, the second module may receive the low-power wake-up signal and the low-power beacon signal.

With reference to the accompanying drawings, the following describes a signal monitoring method, a configuration method, an apparatus, a UE, and a network side device provided in the embodiments of this application in detail by using some embodiments and application scenarios thereof.

FIG. 3 is a flowchart of a signal monitoring method according to an embodiment of this application. The method is performed by a UE. As shown in FIG. 3, the method includes the following steps.

Step 31: The UE determines a first frequency that needs to be monitored.

In this embodiment, the UE may determine, based on a network configuration, a UE capability, and/or the like, the first frequency that needs to be monitored. The first frequency may include one or more frequencies. When the first frequency includes a plurality of frequencies, the UE determines a list of a plurality of frequencies that need to be monitored.

In some embodiments, the first frequency is, for example, an Absolute Radio-Frequency Channel Number (ARFCN)-ValueNR, an ARFCN Evolved Universal Mobile Telecommunications System Terrestrial Radio Access (ARFCN-ValueEUTRA) network, and/or ARFCN-ValueUTRA Frequency Division Duplex (FDD) (ARFCN-ValueUTRA-FDD).

In some embodiments, the UE may be configured to monitor the plurality of frequencies in a low-power state/mode.

Step 32: The UE monitors a first signal corresponding to the first frequency in the low-power state.

In this embodiment, the first signal is a signal that the UE needs to monitor in the low-power state, and the first signal is not a wake-up signal. The first signal may be referred to as, but is not limited to, a low-power beacon signal, a keep-active signal, a keep-alive signal, a signal for synchronization, or the like.

It should be noted that monitoring or detecting the first signal is mainly used for maintaining synchronization between the UE and a network, so that the UE monitors the wake-up signal in a state of being synchronized with the network. In addition, by monitoring or detecting the first signal, some information related to the wake-up signal, for example, time information related to a monitoring occasion of the wake-up signal, may further be obtained, facilitating monitoring the wake-up signal.

The low-power state may be understood as a state in which the UE enters a low-power receiver mode after turning off a main communication module or turning off most working modules of the main communication module, and may include, but is not limited to, at least one of the following: The UE turns off a main receiver, the UE turns on a low-power receiver, or the main receiver of the UE is in a state close to being turned off.

According to the signal monitoring method in this embodiment of this application, a UE may determine a first frequency that needs to be monitored, and monitor a first signal corresponding to the first frequency in a low-power state. The first signal is a signal that the UE needs to monitor in the low-power state. Therefore, a first signal may be associated with a frequency, so that the UE can monitor the first signal corresponding to the frequency in the low-power state.

In this embodiment of this application, before determining the first frequency that needs to be monitored, the UE may receive a first message from a network side device. The first message includes at least one set of configuration information of the first signal. Each set of configuration information of the first signal includes a frequency identifier. For example, each set of configuration information of the first signal is associated with a frequency, a first signal corresponds to a frequency, and the first message is used for indicating a first signal corresponding to a frequency/frequencies monitored by the UE in the low-power state/mode. Then, the UE may determine a frequency corresponding to the frequency identifier included in the at least one set of configuration information of the first signal as the first frequency that needs to be monitored. In some alternative embodiments, based on the first message and information about a frequency supported by the UE, that is, based on a plurality of sets of configuration information of the first signal included in the first message of the network and the UE capability, the UE selects the first frequency from the frequency corresponding to the frequency identifier included in the at least one set of configuration information of the first signal. For example, one or more frequencies may be selected. In this way, the frequency that needs to be monitored may be determined based on the network configuration.

In some embodiments, the UE may receive the first message from the network side device through at least one of the following: a system message, a Radio Resource Control (RRC) reconfiguration message, an RRC release message, a Non-Access Stratum, NAS message, or the like.

In some embodiments, when the first message includes a plurality of sets of configuration information of the first signal in one-to-one correspondence to the plurality of frequencies, all parameters of the plurality of sets of configuration information of the first signal may be the same, or a part of the parameters may be the same, or all the parameters are not the same.

In some embodiments, the first message may further include at least one of the following: an identifier of a frequency in a service area corresponding to the first signal, an identifier of the service area corresponding to the first signal, or a strength threshold of the first signal. Based on the identifier of the service area, the UE may monitor the first signal in the corresponding service area. Based on the strength threshold of the first signal, the UE may monitor a first signal with signal quality higher than or equal to the strength threshold when monitoring occasions conflict. In other words, the UE monitors a first signal only when signal quality of the first signal is higher than or equal to the strength threshold.

In some embodiments, the service area may include, but is not limited to, at least one of the following:
a serving cell, for example, a cell;
a Tracking Area (TA);
a RAN-based Notification Area; or
a plurality of predefined or preconfigured cells.

In some embodiments, the signal quality includes, but is not limited to, a Reference Signal Received Power (RSRP), Reference Signal Received Quality (RSRQ), a Signal to Interference plus Noise Ratio (SINR), and the like.

In some embodiments, when determining, based on the first message, the first frequency that needs to be monitored, the UE may further determine a first signal/signals for monitoring in the low-power state/mode with reference to the UE capability.

In some embodiments, if the UE is configured to monitor first signals corresponding to a plurality of frequencies in the low-power state/mode, the UE may monitor a plurality of first signals based on configuration information of first signals corresponding to different frequencies.

In some embodiments, the frequency associated with the configuration information of the first signal may be determined based on at least one of the following:

(1) A frequency of the service area of the UE. For example, configuration information of an associated/corresponding first signal may be configured for each frequency in the service area. In this case, the number of sets of configuration information of the first signal included in the first message is equal to the number of frequencies corresponding to the service area of the UE.

(2) A measurement result of a frequency of the service area of the UE. For example, the frequency in the service area of the UE and the measurement result thereof may be superimposed, and configuration information of an associated first signal is configured for a frequency whose measurement result meets a preset condition. The measurement result is determined, for example, based on a measurement report of the UE.

The service area is an area in which the UE may receive the first signal that needs to be monitored in the low-power state.

For example, if the service area of the UE has three frequencies, the network side device configures configuration information of first signals associated with/corresponding to the three frequencies. Further, based on measurement results, if measurement results of only two of the three frequencies exceed a threshold, where the threshold is predefined/agreed in a protocol/configured by a network, configuration information of first signals associated with/corresponding to the two frequencies is configured.

(3) Information about a frequency supported by the UE. For example, configuration information of an associated/corresponding first signal may be configured for the frequency supported by the UE.

(4) Network implementation. For example, the network side device may randomly select a plurality of frequencies, or select a plurality of frequencies based on some context information of the UE, and configure configuration information of associated/corresponding first signals for the plurality of frequencies.

In some embodiments, the configuration information of the first signal may include, but is not limited to, at least one of the following:
an identifier of the frequency corresponding to the first signal;
an identifier of the first signal;
an identifier or an identifier list of the wake-up signal;
a sequence corresponding to the first signal;
a start position of a cycle of the first signal;
a period of the first signal;
the number of first signals included in a cycle of a first signal;
a length of a first signal;
a format of the first signal;
a time offset within a cycle of a first signal; or
a time interval between two adjacent first signals included in a cycle of a first signal.

In some embodiments, when the first frequency includes a plurality of frequencies that need to be monitored, and monitoring occasions of a plurality of first signals corresponding to the plurality of frequencies conflict, that the first signal corresponding to the first frequency is monitored may include at least one of the following:
the UE monitors a first signal with highest signal quality in the plurality of first signals;
the UE monitors a first signal with signal quality higher than or equal to a strength threshold in the plurality of first signals, where the strength threshold may be configured by a network side, for example, sent to the UE through the first message;
the UE monitors a first signal with a highest priority in the plurality of first signals, where a monitoring priority may be configured by a network side/predefined/agreed in a protocol, or the like;
the UE monitors a first signal with an earliest monitoring occasion in the plurality of first signals;
the UE monitors one or more of the plurality of first signals based on implementation of the UE;
the UE monitors the plurality of first signals simultaneously or alternately, where, for example, when monitoring occasions conflict, the UE may monitor a first signal corresponding to a frequency 1 in a length of 0^{th} to (N−1)^{th} first signals, monitor a first signal corresponding to a frequency 2 in a length of N^{th} to (2N−1)^{th} first signals, . . . , and subsequently monitor the first signal corresponding to the frequency 1, . . . ;
the UE monitors, based on a configured period of the first signal, a first signal whose period meets a preset condition in the plurality of first signals, where the preset condition may be set based on an actual requirement, for example, a first signal whose period is less than a preset threshold may be monitored, or a first signal with a shortest period in the plurality of first signals may be monitored; or
the UE monitors a second signal in the plurality of first signals based on the number of first signals included in a configured cycle of the first signal, where the number of first signals included in a cycle of the second signal meets a preset condition, where the preset condition may be set based on an actual requirement, for example, a first signal with a signal cycle in which the number of included first signals is greater than a preset threshold may be monitored, or a first signal with a signal cycle including the largest number of first signals may be monitored.

In some embodiments, that the first frequency that needs to be monitored is determined may include at least one of the following:
(1) the UE determines, based on information of a frequency of a first signal supported by the UE, the first frequency that needs to be monitored, for example, the UE may determine the frequency supported by the UE as the first frequency that needs to be monitored;
(2) the UE determines, based on information about a frequency monitored in a non-low-power state, the first frequency that needs to be monitored, for example, the UE may monitor the first signal at the frequency monitored in the non-low-power state/mode; or if the UE obtains a first correspondence between a frequency 1 monitored in the non-low-power state/mode and a frequency 2 monitored in the low-power state/mode, the UE may determine the frequency 2 based on the information about the frequency monitored by the UE in the non-low-power state/mode and the first correspondence, and monitor the first signal on at the frequency 2;
(3) the UE determines a preset frequency as the first frequency that needs to be monitored, where the preset frequency may be a default frequency, and may be predefined/agreed in the protocol/configured by the network; or
(4) based on the frequency identifier included in the at least one set of configuration information of the first signal configured by the network side, the UE determines the frequency corresponding to the frequency identifier as the first frequency.

In some embodiments, if the UE does not obtain the first message or the obtained first message does not include the information about the frequency of the first signal, the first frequency that needs to be monitored may be determined in any one of the foregoing manners (1) to (3).

In this embodiment of this application, the UE may perform state transition based on a situation of monitoring of the first signal, for example, turning on the main receiver and turning off the low-power receiver, to maintain normal communication.

In some embodiments, when a first condition is met within first time, the UE may perform state transition. The first condition includes, but is not limited, at least one of the following:
no first signal is monitored, none of all first signals corresponding to the first frequency is monitored, or signal quality of each monitored first signal corresponding to the first frequency is lower than a first threshold. The first threshold may be set based on an actual requirement, including being configured by the network, predefined, or agreed in the protocol. That none of all first signals corresponding to the first frequency is monitored may be understood as that none of first signals corresponding to all frequencies included in the first frequency are monitored. The first time may be configured by the network, predefined, and/or agreed in the protocol.

In some embodiments, that the state transition is performed may include, but is not limited to, at least one of the following:
the UE turns on the main receiver;
the UE turns off the low-power receiver;
the UE leaves the low-power state; or
the UE enters any one of the following states: an RRC idle state, an RRC inactive state, or an RRC connected state.

In some embodiments, the first time may be any one of the following:
N consecutive cycles of the first signal corresponding to the first frequency, where N is a positive integer, for example, if the first frequency includes a frequency, the first time is the N consecutive cycles of the first signal corresponding to the frequency; or if the first frequency includes a plurality of frequencies, the N consecutive cycles of the first signal corresponding to the first frequency include any one of the following meanings: each first signal corresponding to the first frequency needs to be monitored for N cycles; or the total number of cycles of the first signal corresponding to the monitored first frequency is N;
a length of M consecutive first signals of the first signal corresponding to the first frequency, where M is a positive integer, for example, if the first frequency includes a frequency, the first time is the length of M consecutive first signals of the first signal corresponding to the frequency; or if the first frequency includes a plurality of frequencies, the length of the M consecutive first signals of the first signal corresponding to the first frequency includes any one of the following meanings: the first signal corresponding to the first frequency needs to be monitored for the length of the M first signals; or the total number of the first signals corresponding to the first frequency that are monitored is the length of the M first signals; or
time configured by the network, predefined, or agreed in the protocol.

It should be noted that N and M described above may be set based on an actual requirement, and are not limited therein. A unit of the first time may be, but is not limited to, a slot, a System Frame Number (SFN), a subframe (sub frame), a symbol, a second, a minute, an hour, or the like.

In some embodiments, after performing state transition, the UE may perform cell searching, and may perform at least one of the following:
performing cell searching at the first frequency, for example, if the first frequency includes a plurality of frequencies, the UE may perform cell searching at the plurality of frequencies based on implementation of the UE;
performing cell searching in a cell corresponding to the first frequency;
camping on a cell when the first frequency corresponds to the cell; or
performing cell searching based on a frequency of a serving cell before entering the low-power state/mode.

In some embodiments, the performing cell searching at the first frequency may include at least one of the following:
when the first frequency includes a plurality of frequencies, the UE performs cell searching at the plurality of frequencies in descending order of quality of first signals corresponding to the plurality of frequencies; or
when the first frequency includes a plurality of frequencies, the UE performs cell searching at the plurality of frequencies in descending order of frequency priorities of the plurality of frequencies.

In this way, after the low-power state is exited, a frequency at which cell searching is performed may be determined, thereby reducing a delay in returning to another RRC state from the low-power state.

In some embodiments, after monitoring the first signal corresponding to the first frequency, the UE may monitor a wake-up signal associated with the first signal, and when the UE determines to perform state transition based on a received first wake-up signal, the UE performs cell searching at a frequency corresponding to a first signal associated with the first wake-up signal.

In some embodiments, the Wake-Up Signal (WUS) may be, but is not limited to, an LP_WUS signal, a WUS signal, a low power WUS signal, or the like.

In some embodiments, when the first signal is associated with a plurality of wake-up signals, the first wake-up signal meets at least one of the following:
a wake-up signal closest to the first signal in the plurality of wake-up signals, that is, a wake-up signal appearing earliest;
a wake-up signal with a highest priority in the plurality of wake-up signals;
a randomly selected wake-up signal; or
a wake-up signal selected based on implementation of the UE.

In some embodiments, if configuration information of the wake-up signal is determined or carried by the first signal, the wake-up signal is associated with the first signal, that is, the wake-up signal corresponds to the first signal.

In some embodiments, if the configuration information of the first signal includes an identifier of the wake-up signal, the wake-up signal corresponding to the identifier is associated with the first signal, that is, the wake-up signal corresponds to the first signal.

In some embodiments, the configuration information of the wake-up signal includes, but is not limited to, at least one of the following:
an identifier or an identifier list of the first signal corresponding to the wake-up signal;
an identifier of the wake-up signal;
Discontinuous Reception (DRX) configuration information of the wake-up signal;
a sequence corresponding to the wake-up signal;
a format of the wake-up signal; or
a length of the wake-up signal.

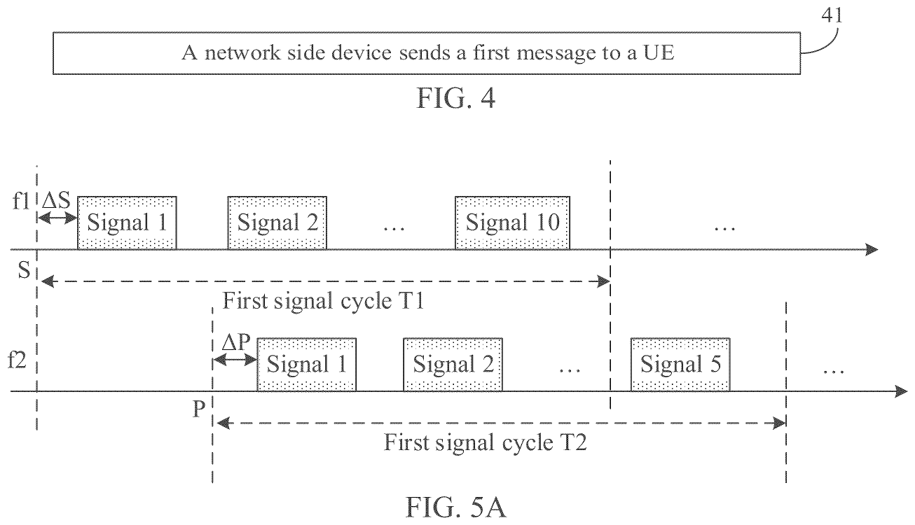

FIG. 4 is a flowchart of a configuration method according to an embodiment of this application. The method is performed by a network side device. As shown in FIG. 4, the method includes the following step.

Step 41: The network side device sends a first message to a UE.

In this embodiment, the first message includes: at least one set of configuration information of a first signal. Each set of configuration information of the first signal includes a frequency identifier. For example, each set of configuration information of the first signal is associated with a frequency, and a first signal corresponds to a frequency. The first signal is a signal that the UE needs to monitor in a low-power state, and the first signal is not a wake-up signal. In this way, the UE can associate the first signal with the frequency through the first message, so that the UE can monitor the first signal corresponding to the frequency in the low-power state.

The low-power state may be understood as a state in which the UE enters a low-power receiver mode after turning off a main communication module, and may include, but is not limited to, at least one of the following: The UE turns off a main receiver, the UE turns on a low-power receiver, or the main receiver of the UE is in a state close to being turned off.

In some embodiments, the frequency associated with the configuration information of the first signal may be determined based on at least one of the following:

(1) A frequency of a service area of the UE. For example, configuration information of an associated/corresponding first signal may be configured for each frequency in the service area, and in this case, the number of sets of configuration information of the first signal included in the first message is equal to the number of frequencies of the service area of the UE.

(2) A measurement result of a frequency of a service area of the UE. For example, the frequency in the service area of the UE and the measurement result thereof may be superimposed, and configuration information of an associated first signal is configured for a frequency whose measurement result meets a preset condition. The measurement result is determined, for example, based on a measurement report of the UE.

For example, if the service area of the UE has three frequencies, the network side device configures configuration information of first signals associated with/corresponding to the three frequencies. Further, based on measurement results, if measurement results of only two of the three frequencies exceed a threshold, where the threshold is predefined/agreed in a protocol/configured by a network, configuration information of first signals associated with/corresponding to the two frequencies is configured.

(3) Information about a frequency supported by the UE. For example, configuration information of an associated/corresponding first signal may be configured for the frequency supported by the UE.

(4) Based on network implementation. For example, the network side device may randomly select a plurality of frequencies, or select a plurality of frequencies based on some context information of the UE, and configure configuration information of associated/corresponding first signals for the plurality of frequencies.

In some embodiments, the network side device may send the first message to the UE through at least one of the following: a system message, an RRC reconfiguration message, an RRC release message, or a NAS message.

This application is described below with reference to examples.

### Example 1

In Example 1, a relationship between a sequence and a frequency of the first signal (for example, a low-power beacon signal) may be agreed in a protocol. For example, a base sequence of the first signal is derived from the frequency of the first signal, and the base sequence is a function of the frequency: w=f(freq). A UE in an RRC_IDLE/RRC_INACTIVE state receives the first message broadcast by the network side device, or the UE in an RRC_CONNECTED state receives the first message through dedicated signaling. The first message includes configuration information of a first signal used by the UE after the UE enters the low-power state in a cell. For example, if the first message includes configuration information of first signals associated with a frequency 1 and a frequency 2, the UE monitors sequences of the first signals corresponding to the frequency 1 and the frequency 2 when the UE is in the low-power state.

### Example 2

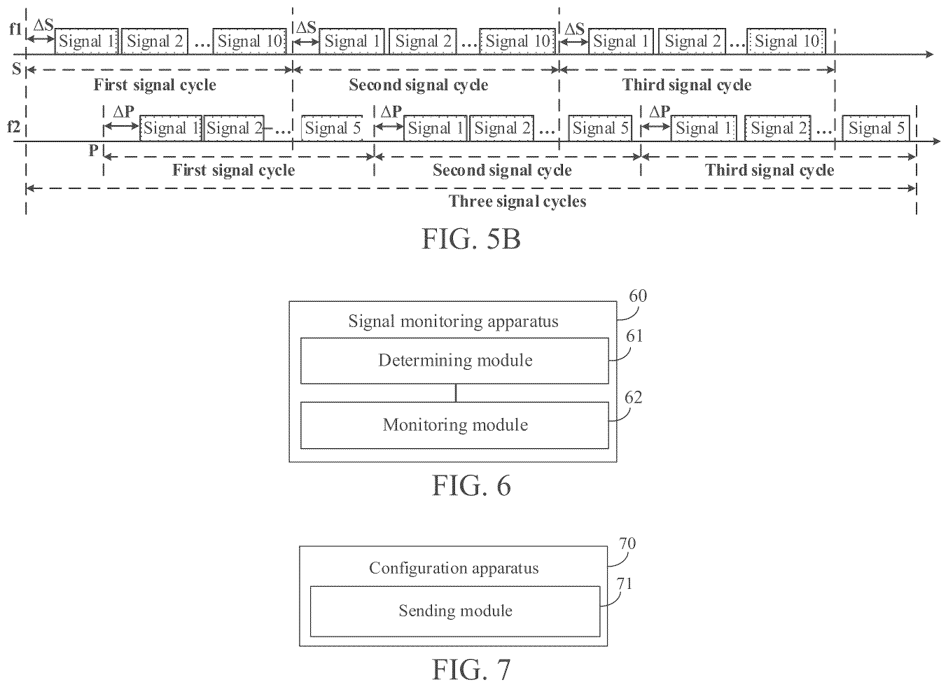

In Example 2, a UE receives the configuration information of the first signal (for example, a low-power beacon signal), which indicates the UE to monitor sequences of first signals corresponding to a frequency 1 and a frequency 2 after entering the low-power state. Monitoring occasions of the first signals corresponding to the frequency 1 and the frequency 2 are shown in FIG. 5A. A start position of a cycle of the first signal corresponding to the frequency 1 is S, a time offset within the cycle of the first signal is ΔS, cycle duration is T1, there are ten first signals in a cycle, and a length of each first signal is L. A start position of a cycle of the first signal corresponding to the frequency 2 is P, a time offset within the cycle of the first signal is ΔP, cycle duration is T2, where T2=T1, there are five first signals in a cycle, and a length of each first signal is L. Therefore, starting at P, the UE may monitor the frequency 1, or may monitor the frequency 2, and the UE may determine, based on the following rules, to monitor a frequency:
the UE monitors a first signal that has highest signal quality or meets a signal quality threshold, where in this case, the UE may first monitor the frequency 1 and then monitor the frequency 2 during a conflict, and after determining which signal has better quality, only monitor a frequency corresponding to the signal with the better signal quality;
the UE monitors the first signal with a signal occasion appearing earliest, where in FIG. 5A, because a signal occasion corresponding to the frequency 1 appears first, the UE only monitors the first signal corresponding to the frequency 1; and if the UE cannot monitor the frequency 1 during S-P, the UE monitors the frequency 2; and
the UE alternately monitors the first signals corresponding to the two frequencies, for example, during a conflict, the UE monitors signals 1, 3, and 5 corresponding to the frequency 2, and monitors signals 2, 4, and 6 corresponding to the frequency 1.

### Example 3

In Example 3, based on the received first message, a UE determines that the UE monitors first signals corresponding to a frequency 1 and a frequency 2 in the low-power state. However, in the low-power state, the UE does not monitor the first signals in three consecutive cycles of the first signals corresponding to the frequency 1 and the frequency 2. As shown in FIG. 5B, the UE first monitors an occasion of the first signal corresponding to the frequency 1 at a moment S, and cannot monitor the first signal corresponding to the frequency 1 all the time, so that the UE starts to monitor an occasion of the first signal corresponding to the frequency 2 at a moment P, and still cannot monitor the first signal corresponding to the frequency 2. Therefore, the UE starts to alternately monitor the occasions of the first signals corresponding to the frequency 1 and the frequency 2. After three cycles, the UE gives up monitoring. The three cycles are agreed in a protocol or configured by a network, and the three cycles are required to ensure that first signals corresponding to all frequencies to be monitored by the UE last three cycles, that is, monitoring starts from a start position of a cycle of an earliest first signal, and monitoring ends until cycles of the first signals of all the frequencies each reach three cycles. Then, a low-power receiver of the UE notifies a main receiver to be turned on, and the low-power receiver is turned off.

### Example 4

In Example 4, a UE returns to another RRC state from the low-power state. A process is as follows.
S1: The UE receives the first message, which indicates the UE to monitor first signals corresponding to a frequency 1 and a frequency 2 when the UE is in the low-power state.
S2: The UE monitors the first signal corresponding to the frequency 1 in the low-power state.
S3: The UE monitors a WUS at a WUS monitoring occasion based on the first signal.
S4: The UE turns off a low-power receiver and turns on a main receiver, and the UE returns to an RRC_IDLE state from the low-power state.
S5: The UE performs cell searching at the frequency 1.
S6: If the UE does not successfully find a cell at the frequency 1, the UE continues to perform cell searching at the frequency 2.
S7: If the UE does not successfully find a cell at the frequency 2 either, the UE starts to perform normal cell searching.

The signal monitoring method provided in the embodiments of this application may be performed by a signal monitoring apparatus. In this embodiment of this application, the signal monitoring apparatus provided in this embodiment of this application is described by using an example in which the signal monitoring apparatus performs the signal monitoring method.

FIG. 6 is a schematic structural diagram of a signal monitoring apparatus according to an embodiment of this application. The apparatus is used in a UE. As shown in FIG. 6, a signal monitoring apparatus 60 includes:
a determining module 61, configured to determine a first frequency that needs to be monitored; and
a monitoring module 62, configured to monitor a first signal corresponding to the first frequency in a low-power state, where the first signal is a signal that the UE needs to monitor in the low-power state, and the first signal is not a wake-up signal.

In some embodiments, the signal monitoring apparatus 60 further includes:
a receiving module, configured to receive a first message from a network side device, where the first message includes: at least one set of configuration information of a first signal. Each set of configuration information of the first signal includes a frequency identifier.

The determining module 61 is configured to perform any one of the following:
determining a frequency corresponding to the frequency identifier included in the at least one set of configuration information of the first signal as the first frequency; or
selecting, based on the first message and information about a frequency supported by the UE, the first frequency from a frequency corresponding to the frequency identifier included in the at least one set of configuration information of the first signal.

In some embodiments, the receiving module is configured to: receive the first message from the network side device through at least one of the following: a system message, an RRC reconfiguration message, an RRC release message, and a non-access stratum NAS message.

In some embodiments, the first message further includes at least one of the following: an identifier of a service area corresponding to the first signal or a strength threshold of the first signal.

In some embodiments, when the first frequency includes a plurality of frequencies, and monitoring occasions of a plurality of first signals corresponding to the plurality of frequencies conflict, the monitoring module 62 is configured to perform at least one of the following:
monitoring a first signal with highest signal quality in the plurality of first signals;
monitoring a first signal with signal quality higher than or equal to a strength threshold in the plurality of first signals;
monitoring a first signal with a highest priority in the plurality of first signals;
monitoring a first signal that appears with an earliest monitoring occasion in the plurality of first signals;
monitoring one or more of the plurality of first signals based on implementation of the monitoring module;
monitoring the plurality of first signals simultaneously or alternately;
monitoring, based on a configured period of the first signal, a first signal whose period meets a preset condition in the plurality of first signals; or
monitoring a second signal in the plurality of first signals based on the number of the first signals included in a configured cycle of the first signal, where the number of the first signals included in a cycle of the second signal meets a preset condition.

In some embodiments, the determining module 61 is configured to perform at least one of the following:
determining, based on information about a frequency of a first signal supported by the determining module, the first frequency that needs to be monitored;
determining, based on information about a frequency monitored in a non-low-power state, the first frequency that needs to be monitored; or
determining a preset frequency as the first frequency that needs to be monitored.

In some embodiments, the signal monitoring apparatus 60 further includes:
an execution module, configured to perform state transition in a case that a first condition is met within first time. The first condition includes at least one of the following:
no first signal is monitored, none of all first signals corresponding to the first frequency is monitored, or signal quality of each monitored first signal corresponding to the first frequency is lower than a first threshold.

In some embodiments, the first time is any one of the following:
N consecutive cycles of the first signal corresponding to the first frequency, where N is a positive integer;
a length of M consecutive first signals of the first signal corresponding to the first frequency, where M is a positive integer; or
time configured by a network, predefined, or agreed in a protocol.

In some embodiments, the execution module is configured to perform at least one of the following:
turning on a main receiver;
turning off a low-power receiver;
leaving a low-power state; or
entering any one of the following states: an RRC idle state, an RRC inactive state, or an RRC connected state.

In some embodiments, the execution module is further configured to perform at least one of the following after the state transition:
performing cell searching at the first frequency;
performing cell searching in a cell corresponding to the first frequency;
camping on a cell when the first frequency corresponds to the cell; or
performing cell searching based on a frequency of a serving cell before entering the low-power state.

In some embodiments, the execution module is configured to perform at least one of the following:
when the first frequency includes a plurality of frequencies, performing cell searching at the plurality of frequencies in descending order of signal quality of the first signal corresponding to the plurality of frequencies; or
when the first frequency includes a plurality of frequencies, performing cell searching at the plurality of frequencies in descending order of frequency priorities of the plurality of frequencies.

In some embodiments, the monitoring module 62 is further configured to: monitor a wake-up signal associated with the first signal.

The execution module is further configured to: when the UE determines to perform state transition based on a received first wake-up signal, perform cell searching at a frequency corresponding to a first signal associated with a first wake-up signal.

In some embodiments, when the first signal is associated with a plurality of wake-up signals, the first wake-up signal meets at least one of the following:
a wake-up signal closest to the first signal in the plurality of wake-up signals;
a wake-up signal with a highest priority in the plurality of wake-up signals;
a randomly selected wake-up signal; or
a selected wake-up signal based on implementation of the UE.

The signal monitoring apparatus 60 in this embodiment of this application may be an electronic device, for example, an electronic device with an operating system, or may be a component in an electronic device, for example, an integrated circuit or a chip. The electronic device may be a UE, or may be another device other than a UE. For example, the UE may include, but is not limited to, the types of the UE 11 listed above, and the another device may be a server, a network attached storage, or the like. This is not specifically limited in this embodiment of this application.

The signal monitoring apparatus 60 provided in this embodiment of this application can implement the processes implemented in the method embodiment shown in FIG. 3, and can achieve the same technical effect. To avoid repetition, details are not described herein.

FIG. 7 is a schematic structural diagram of a configuration apparatus according to an embodiment of this application. The apparatus is used in a network side device. As shown in FIG. 7, a configuration apparatus 70 includes:
a sending module 71, configured to send a first message to a UE. The first message includes: at least one set of configuration information of a first signal. Each set of configuration information of the first signal includes a frequency identifier, the first signal is a signal that needs to be monitored by the UE in a low-power state, and the first signal is not a wake-up signal.

In some embodiments, a frequency corresponding to the frequency identifier included in the at least one set of configuration information of the first signal is determined based on at least one of the following:
a frequency of a service area of the UE; a measurement result of a frequency of a service area of the UE; information about a frequency supported by the UE; or network implementation.

In some embodiments, the sending module 71 is configured to: send the first message to the UE through at least one of the following:
a system message, an RRC reconfiguration message, an RRC release message, or a NAS message.

The configuration apparatus 70 provided in this embodiment of this application can implement the processes implemented in the method embodiment shown in FIG. 4, and can achieve the same technical effect. To avoid repetition, details are not described herein.

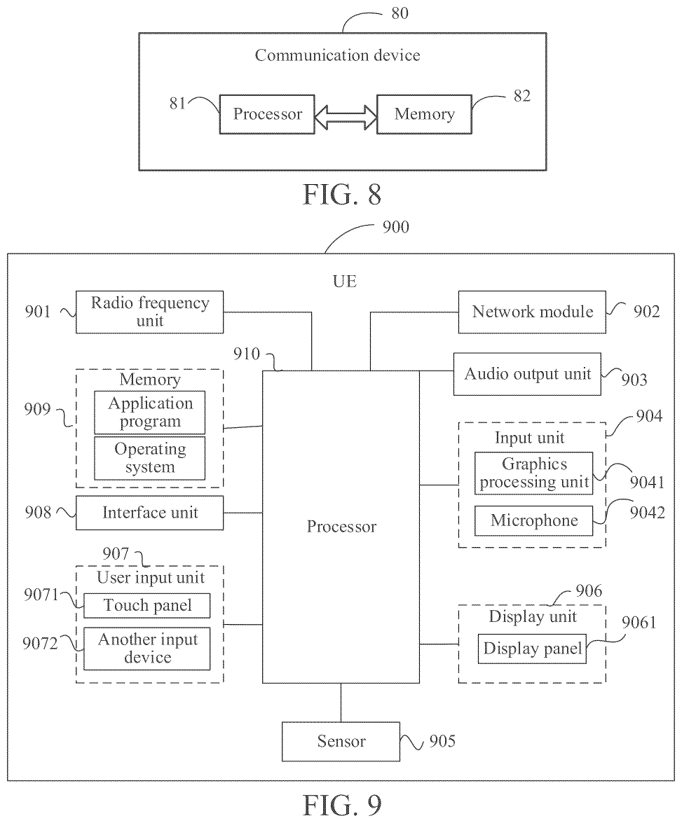

For example, as shown in FIG. 8, an embodiment of this application further provides a communication device 80, including a processor 81 and a memory 82. The memory 82 has a program or instructions executable on the processor 81 stored therein. For example, when the communication device 80 is a UE, when the program or the instructions are executed by the processor 81, the steps of the embodiments of the signal monitoring method are implemented, and the same technical effect can be achieved. When the communication device 80 is a network side device, when the program or the instructions are executed by the processor 81, the steps of the embodiments of the configuration method are implemented, and the same technical effect can be achieved. To avoid repetition, details are not described herein.

An embodiment of this application further provides a UE, including a processor and a communication interface. The processor is configured to determine a first frequency that needs to be monitored; and monitor a first signal corresponding to the first frequency in a low-power state, where the first signal is a signal that the UE needs to monitor in the low-power state, and the first signal is not a wake-up signal. The UE embodiment corresponds to the foregoing method embodiment of the UE side. Implementation processes and implementations of the foregoing method embodiment are all applicable to the UE embodiment, and the same technical effect can be achieved.

For example, FIG. 9 is a schematic diagram of a hardware structure of a UE implementing an embodiment of this application.

A UE 900 includes, but is not limited to: at least a part of components such as a radio frequency unit 901, a network module 902, an audio output unit 903, an input unit 904, a sensor 905, a display unit 906, a user input unit 907, an interface unit 908, a memory 909, and a processor 910.

A person skilled in the art may understand that the UE 900 may further include a power supply (such as a battery) for supplying power to the components. The power supply may be logically connected to the processor 910 through a power management system, thereby implementing functions such as charging, discharging, and power management by using the power management system. The structure of the UE shown in FIG. 9 does not constitute a limitation on the UE, and the UE may include more or fewer components than shown, or combine some components, or have different component arrangements, which is not described herein in detail.

It should be understood that in this embodiment of this application, the input unit 904 may include a Graphics Processing Unit (GPU) 9041 and a microphone 9042. The graphics processing unit 9041 performs processing on image data of a static picture or a video that is obtained by an image acquisition device (for example, a camera) in a video acquisition mode or an image acquisition mode. The display unit 906 may include a display panel 9061. The display panel 9061 may be configured in a form of a liquid crystal display, an organic light-emitting diode, or the like. The user input unit 907 includes at least one of a touch panel 9071 and another input device 9072. The touch panel 9071 is also referred to as a touchscreen. The touch panel 9071 may include two parts: a touch detection apparatus and a touch controller. The another input device 9072 may include, but is not limited to, a physical keyboard, a functional key (such as a volume control key or a switch key), a track ball, a mouse, and a joystick, which is not described herein in detail.

In this embodiment of this application, after receiving downlink data from a network side device, the radio frequency unit 901 may transmit the downlink data to the processor 910 for processing. In addition, the radio frequency unit 901 may send uplink data to the network side device. Generally, the radio frequency unit 901 includes, but is not limited to, an antenna, an amplifier, a transceiver, a coupler, a low noise amplifier, a duplexer, and the like.

The memory 909 may be configured to store a software program or instructions and various data. The memory 909 may mainly include a first storage area for storing the program and a second storage area for storing the data. The first storage area may store an operating system, an application program or instructions required for at least one function (for example, a sound playback function and an image display function), and the like. In addition, the memory 909 may include a volatile memory or a non-volatile memory, or the memory 909 may include both a volatile memory and a non-volatile memory. The non-volatile memory may be a Read-Only Memory (ROM), a Programmable ROM (PROM), an Erasable PROM (EPROM), an Electrically EPROM (EEPROM) or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), or a Direct Rambus RAM (DRRAM). The memory 909 in this embodiment of this application includes, but is not limited to, these memories and any other suitable types.

The processor 910 may include one or more processing units. In some embodiments, the processor 910 integrates an application processor and a modem processor. The application processor mainly processes operations related to an operating system, a user interface, an application program, and the like. The modem processor mainly processes wireless communication signals, for example, a baseband processor. It may be understood that, the modem processor may not be integrated into the processor 910.

The processor 910 is configured to determine a first frequency that needs to be monitored; and monitor a first signal corresponding to the first frequency in a low-power state, where the first signal is a signal that the UE needs to monitor in the low-power state, and the first signal is not a wake-up signal.

The UE 900 provided in this embodiment of this application can implement the processes implemented in the method embodiment shown in FIG. 3, and can achieve the same technical effect. To avoid repetition, details are not described herein.

An embodiment of this application further provides a network side device, including a processor and a communication interface. The communication interface is configured to send a first message to a UE. The first message includes: at least one set of configuration information of a first signal. Each set of configuration information of the first signal includes a frequency identifier, the first signal is a signal that needs to be monitored by the UE in a low-power state, and the first signal is not a wake-up signal. The network side device embodiment corresponds to the foregoing method embodiment of the network side device. Implementation processes and implementations of the foregoing method embodiment are all applicable to the network side device embodiment, and the same technical effect can be achieved.

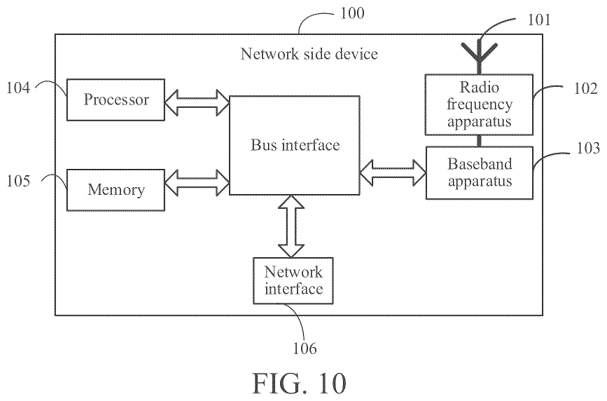

For example, an embodiment of this application further provides a network side device. As shown in FIG. 10, a network side device 100 includes: an antenna 101, a radio frequency apparatus 102, a baseband apparatus 103, a processor 104, and a memory 105. The antenna 101 is connected to the radio frequency apparatus 102. In an uplink direction, the radio frequency apparatus 102 receives information through the antenna 101, and sends the received information to the baseband apparatus 103 for processing. In a downlink direction, the baseband apparatus 103 processes to-be-sent information and sends information to the radio frequency apparatus 102. The radio frequency apparatus 102 processes the received information and then sends information through the antenna 101.

The method performed by the network side device in the foregoing embodiment may be implemented in the baseband apparatus 103. The baseband apparatus 103 includes a baseband processor.

The baseband apparatus 103 may include, for example, at least one baseband board. A plurality of chips are arranged on the baseband board. As shown in FIG. 10, one of the chips is, for example, a baseband processor, and is connected to the memory 105 through a bus interface, to invoke a program in the memory 105 to perform network device operations shown in the foregoing method embodiments.

The network side device may further include a network interface 106. The interface is, for example, a Common Public Radio Interface (CPRI).

For example, the network side device 100 in this embodiment of this application further includes: instructions or a program stored in the memory 105 and executable on the processor 104. The processor 104 invokes the instructions or the program in the memory 105 to perform the method performed by the modules shown in FIG. 7, and the same technical effect is achieved. To avoid repetition, details are not described herein.

An embodiment of this application further provides a readable storage medium. The readable storage medium has a program or instructions stored therein. When the program or the instructions are executed by a processor, the processes of the embodiments of the signal monitoring method are implemented, and the same technical effect can be achieved. To avoid repetition, details are not described herein.

The processor is the processor in the UE described in the foregoing embodiment. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to execute a program or instructions, to implement the processes of the embodiments of the signal monitoring method, and the same technical effect can be achieved. To avoid repetition, details are not described herein.

It should be understood that the chip mentioned in this embodiment of this application may also be referred to as a system-level chip, a system chip, a chip system, a system on a chip, or the like.

An embodiment of this application further provides a computer program/program product. The computer program/program product is stored in a storage medium. The computer program/program product is executed by at least one processor, to implement the processes of the embodiments of the signal monitoring method, and the same technical effect can be achieved. To avoid repetition, details are not described herein.

An embodiment of this application further provides a communication system, including a UE and a network side device. The UE may be configured to perform the steps of the signal monitoring method described above, and the network side device may be configured to perform the steps of the configuration method described above.

It should be noted that terms “include”, “comprise”, or any other variation thereof in this specification is intended to cover a non-exclusive inclusion, which specifies the presence of stated processes, methods, objects, or apparatuses, but do not preclude the presence or addition of one or more other processes, methods, objects, or apparatuses. Without more limitations, elements defined by the sentence “including one . . . ” does not exclude that there are still other same elements in the processes, methods, objects, or apparatuses. In addition, it should be noted that the scope of the method and apparatus in the implementations of this application is not limited to performing the functions in the order shown or discussed, and may further include performing the functions in a substantially simultaneous manner or in reverse order according to the involved functions. For example, the described method may be performed in an order different from the described order, and various steps may further be added, omitted, or combined. In addition, features described with reference to some examples may be combined in other examples.

Through the descriptions of the foregoing implementations, a person skilled in the art may clearly understand that the method according to the foregoing embodiments may be implemented by using software and a necessary general hardware platform, or may be implemented by hardware, but in many cases, the former manner is a better implementation. Based on such an understanding, the technical solutions of this application essentially or the part contributing to the related art may be implemented in a form of a computer software product. The computer software product is stored in a storage medium (such as a ROM/RAM, a magnetic disk, or an optical disc) and includes several instructions for instructing a UE (which may be a mobile phone, a computer, a server, an air conditioner, a network device, or the like) to perform the methods described in the embodiments of this application.

The embodiments of this application are described above with reference to the accompanying drawings. This application is not limited to the implementations described above, and the implementations described above are merely exemplary and not limitative. A person of ordinary skill in the art may make various variations under the teaching of this application without departing from the spirit of this application and the protection scope of the claims, and such variations shall all fall within the protection scope of this application.

What is claimed is:

1. A signal monitoring method, comprising:
determining, by a User Equipment (UE), a first frequency that needs to be monitored; and
monitoring, by the UE, a first signal corresponding to the first frequency in a low-power state, wherein the first signal is not a wake-up signal.

2. The signal method according to claim 1, wherein before determining the first frequency that needs to be monitored, the method further comprises:
receiving, by the UE, a first message from a network side device, wherein the first message comprises: at least one set of configuration information of the first signal, wherein each set of the configuration information of the first signal comprises a frequency identifier, wherein
determining the first frequency that needs to be monitored comprises any one of the following:
determining, by the UE, a frequency corresponding to the frequency identifier comprised in the at least one set of the configuration information of the first signal as the first frequency; or
selecting, by the UE based on the first message and information about a frequency supported by the UE, the first frequency from a frequency corresponding to the frequency identifier comprised in the at least one set of the configuration information of the first signal.

3. The signal method according to claim 2, wherein receiving the first message from the network side device comprises:
receiving, by the UE, the first message from the network side device through at least one of the following:
a system message, a Radio Resource Control (RRC) reconfiguration message, an RRC release message, or a Non-Access Stratum (NAS) message.

4. The signal method according to claim 2, wherein the first message further comprises at least one of the following: an identifier of a service area corresponding to the first signal, or a strength threshold of the first signal.

5. The signal method according to claim 1, wherein when the first frequency comprises a plurality of frequencies, and monitoring occasions of a plurality of first signals corresponding to the plurality of frequencies conflict, monitoring the first signal corresponding to the first frequency comprises at least one of the following:
monitoring, by the UE, a first signal with highest signal quality in the plurality of first signals;
monitoring, by the UE, a first signal with signal quality higher than or equal to a strength threshold in the plurality of first signals;
monitoring, by the UE, a first signal with a highest priority in the plurality of first signals;
monitoring, by the UE, a first signal with an earliest monitoring occasion in the plurality of first signals;
monitoring, by the UE, one or more of the plurality of first signals based on implementation of the UE;
monitoring, by the UE, the plurality of first signals simultaneously or alternately;
monitoring, by the UE based on a configured period of the first signal, a first signal whose period meets a preset condition in the plurality of first signals; or
monitoring, by the UE, a second signal in the plurality of first signals based on the number of first signals comprised in a configured cycle of the first signal, wherein the number of first signals comprised in a cycle of the second signal meets a preset condition.

6. The signal method according to claim 1, wherein determining the first frequency that needs to be monitored comprises at least one of the following:
determining, by the UE based on information about a frequency of a first signal supported by the UE, the first frequency that needs to be monitored;
determining, by the UE based on information about a frequency monitored in a non-low-power state, the first frequency that needs to be monitored; or
determining, by the UE, a preset frequency as the first frequency that needs to be monitored.

7. The signal method according to claim 1, further comprising:
performing, by the UE, state transition when a first condition is met within first time, wherein
the first condition comprises at least one of the following:
no first signal is monitored,
none of all first signals corresponding to the first frequency is monitored, or
signal quality of each monitored first signal corresponding to the first frequency is lower than a first threshold.

8. The signal method according to claim 7, wherein the first time is any one of the following:
N consecutive cycles of the first signal corresponding to the first frequency, wherein N is a positive integer;
a length of M consecutive first signals of the first signal corresponding to the first frequency, wherein M is a positive integer; or
time configured by a network, predefined, or agreed in a protocol.

9. The signal method according to claim 7, wherein performing the state transition comprises at least one of the following:
turning on, by the UE, a main receiver;
turning off, by the UE, a low-power receiver;
leaving, by the UE, the low-power state; or
entering, by the UE, any one of the following states: a Radio Resource Control (RRC) idle state, an RRC inactive state, or an RRC connected state.

10. The signal method according to claim 7, wherein after performing the state transition, the method further comprises at least one of the following:
performing, by the UE, cell searching at the first frequency;
performing, by the UE, cell searching in a cell corresponding to the first frequency;
camping, by the UE, on a cell when the first frequency corresponds to the cell; or
performing, by the UE, cell searching based on a frequency of a serving cell before entering the low-power state.

11. The signal method according to claim 10, wherein performing the cell searching at the first frequency comprises at least one of the following:
when the first frequency comprises a plurality of frequencies, performing, by the UE, the cell searching at the plurality of frequencies in descending order of signal quality of first signals corresponding to the plurality of frequencies; or
when the first frequency comprises a plurality of frequencies, performing, by the UE, the cell searching at the plurality of frequencies in descending order of frequency priorities of the plurality of frequencies.

12. The signal method according to claim 1, wherein after monitoring the first signal corresponding to the first frequency, the method further comprises:
monitoring, by the UE, a wake-up signal associated with the first signal; and
when the UE determines to perform state transition based on a received first wake-up signal, performing, by the UE, cell searching at a frequency corresponding to a first signal associated with the first wake-up signal.

13. The signal method according to claim 12, wherein when the first signal is associated with a plurality of wake-up signals, the first wake-up signal meets at least one of the following:
a wake-up signal closest to the first signal in the plurality of wake-up signals;
a wake-up signal with a highest priority in the plurality of wake-up signals;
a randomly selected wake-up signal; or
a wake-up signal selected based on implementation of the UE.

14. A configuration method, comprising:
sending, by a network side device, a first message to a User Equipment (UE), wherein the first message comprises: at least one set of configuration information of a first signal, wherein:
each set of the configuration information of the first signal comprises a frequency identifier,
the first signal is a signal that needs to be monitored by the UE in a low-power state, and
the first signal is not a wake-up signal.

15. The signal method according to claim 14, wherein a frequency corresponding to the frequency identifier comprised in the at least one set of the configuration information of the first signal is determined based on at least one of the following: a frequency of a service area of the UE; a measurement result of a frequency of a service area of the UE; information about a frequency supported by the UE; or network implementation.

16. The signal method according to claim 14, wherein sending the first message to the UE comprises:
sending, by the network side device, the first message to the UE through at least one of the following: a system message, an Radio Resource Control (RRC) reconfiguration message, an RRC release message, or a Non-Access Stratum (NAS) message.

17. A User Equipment (UE), comprising a processor and a memory having a computer program or an instruction stored thereon, wherein the computer program or the instruction, when executed by the processor, causes the processor to perform operations comprising:
determining a first frequency that needs to be monitored; and
monitoring a first signal corresponding to the first frequency in a low-power state, wherein the first signal is not a wake-up signal.

18. The UE according to claim 17, wherein before determining the first frequency that needs to be monitored, the operations further comprise:
receiving a first message from a network side device, wherein the first message comprises: at least one set of configuration information of the first signal, wherein each set of the configuration information of the first signal comprises a frequency identifier, wherein
determining the first frequency that needs to be monitored comprises any one of the following:
determining a frequency corresponding to the frequency identifier comprised in the at least one set of the configuration information of the first signal as the first frequency; or
selecting, based on the first message and information about a frequency supported by the UE, the first frequency from a frequency corresponding to the frequency identifier comprised in the at least one set of the configuration information of the first signal.

19. The UE according to claim 18, wherein receiving the first message from the network side device comprises:
receiving the first message from the network side device through at least one of the following:
a system message, a Radio Resource Control (RRC) reconfiguration message, an RRC release message, or a Non-Access Stratum (NAS) message.

20. The UE according to claim 18, wherein the first message further comprises at least one of the following: an identifier of a service area corresponding to the first signal, or a strength threshold of the first signal.
